(19) United States
(12) Patent Application Publication
(10) Pub. No.: US 2012/0296684 A1
(43) Pub. Date: Nov. 22, 2012

(54) TASK ASSIGNMENT IN A WORKFLOW SYSTEM

(75) Inventors: Samuel J. Burri, Rueschlikon (CH); Guenter Karjoth, Rueschlikon (CH)

(73) Assignee: INTERNATIONAL BUSINESS MACHINES CORPORATION, Armonk, NY (US)

(21) Appl. No.: 13/562,922

(22) Filed: Jul. 31, 2012

Related U.S. Application Data
(63) Continuation of application No. 13/363,783, filed on Feb. 1, 2012.

(30) Foreign Application Priority Data
Feb. 4, 2011 (EP) 11153310.5

(51) Int. Cl. G06Q 10/06

(52) U.S. Cl. 705/7.14

(57) ABSTRACT

A computer-implemented method for assigning a task in a workflow system to a user of the workflow system includes receiving the task; determining, by a computer, a set of users who are authorized to perform the received task; selecting from the set a user who has the lowest flexibility to perform other tasks in the workflow system; and assigning the task to the selected user.

### PRIORITY

This application is a continuation of U.S. patent application Ser. No. 13/363,783, filed Feb. 1, 2012, which claims priority to European Patent Application No. 11153310.5, filed 4 Feb. 2011, and all the benefits accruing therefrom under 35 U.S.C. §119, the contents of which in its entirety are herein incorporated by reference.

### BACKGROUND

The present invention relates to task assignment in a workflow system. Specifically, the invention relates to a computer-implemented method and a system for assigning a task in a workflow system to a user of the workflow system.

A workflow models the temporal ordering and causal dependencies of tasks that together implement a business objective. A task is a unit of work that may be a human task to be executed by humans, or an automated task to be executed by machines. For example, a business objective may be the process which is required to proceed from a loan request to an approval or rejection of the request. The associated workflow may comprise a first task in which the request is reviewed and a second task in which an outcome of the review is verified. One objective of a workflow system is to assign the tasks to users. In this, there may be certain restrictions or requirements. For instance, the user carrying out the first task may be required to be different from the user carrying out the second task. Also, the user carrying out the second task may be required to be in a certain position within the organization or in a (hierarchical) relationship with the user who executed the first task. In the current example, the first user may be an accountant and the second user may be a manager. A workflow system may be implemented in many fashions, although it is common to execute some of the logic of a workflow system on a computer by a so-called workflow engine.

Assigning a task to a user is one crucial objective of a workflow system. If a user is assigned too many tasks, processing of some of the tasks may be delayed and the associated workflow process may stagnate. Furthermore, depending on previously made assignments of tasks to users, a situation may arise in which no user is available for a certain task to be assigned. In some cases, there may even be a deadlock because no assignable user is left who fulfills the required authorizations and the imposed restrictions. By avoiding stagnations and deadlocks, productivity may be increased, time may be saved, costs may be cut, and quality may be improved.

US 2009/0198548 A1 proposes a computer-implemented method for avoiding policy-based deadlocks during the execution of a workflow. One limitation of the proposed method is that the analysis is performed at design time, not considering the current status of the resources. Furthermore, only deadlock prevention is addressed.

### SUMMARY

According to an embodiment of the invention, a computer-implemented method for assigning a task in a workflow system to a user of the workflow system includes receiving the task, determining a set of users who are authorized to perform the received task, selecting from the set a user who has the lowest flexibility to perform other tasks in the workflow system, and assigning the task to the selected user.

In another embodiment, a computer readable storage medium having computer readable instructions stored thereon that, when executed by a computer, implement a method of assigning a task in a workflow system to a user of the workflow system. The method includes receiving the task; determining a set of users who are authorized to perform the received task; selecting from the set a user who has the lowest flexibility to perform other tasks in the workflow system; and assigning the task to the selected user.

In another embodiment, a system for assigning a task in a workflow system to a user of the workflow system includes reception means for receiving the task; determination means for determining a set of users who are authorized to perform the received task; a selection unit for selecting from the set a user who has the lowest flexibility to perform other tasks in the workflow system; and assignment means for assigning the task to the selected user.

In still another embodiment, a computer system for assigning a task of a workflow system to a user of the workflow system includes an input interface for receiving the task; a memory unit for storing user authorizations; a processing unit being operable to determine a set of users who are authorized to perform the received task and to select from the set a user who has the lowest flexibility to perform other tasks of the workflow system; and to assign the task to the selected user.

### BRIEF DESCRIPTION OF THE DRAWINGS

Referring to the exemplary drawings wherein like elements are numbered alike in the several Figures:

FIG. 1 shows a system for assigning a task in a workflow system to a user of the workflow system, in accordance with an embodiment;

FIG. 2 shows a flowchart of an exemplary method for assigning a task to a user, in accordance with an embodiment;

FIG. 3 shows a flowchart of another method for assigning a task to a user, in accordance with an embodiment;

FIG. 4 shows a flowchart of an exemplary workflow; and

FIG. 5 shows an exemplary relationship between users and roles.

### DETAILED DESCRIPTION

According to embodiments of the invention, specialized users who are restricted to the execution of certain tasks are preferred when selecting a user for the task, while a generalist user who may execute a variety of tasks is kept for later. This effects that in a higher stage of a given workflow, the number of users in the set to choose from for assigning a task of the workflow to is still large enough, i.e., one or more, to prevent stalling of the workflow and potentially hitting a deadlock.

Such a heuristic approach for selecting the user may not yield an ideal selection in all cases, but it will yield a good selection in most cases. As only relevant information is considered for making the selection, the heuristic approach according to embodiments of the invention is generally faster than an exhaustive computation of all possible selections. Furthermore an exhaustive computation may not always be possible due to complexity and size of the underlying optimization problem.

According to a further embodiment of the invention, a set of rules called a policy may be employed to select from a large set of users a set that fulfills a certain predefined criterion such as a level of an authorization or an availability of the users. The selection of the user that shall perform the task is then performed on the subset. According to a further embodiment, the set of users is determined on the basis of a policy which is dynamic in that it considers a state of the user and/or a task at the time of determining the set. In this way, the set of users can be determined on the basis of the freshest/latest and the most relevant information. This may lead to higher determination accuracy and less computational effort.

According to embodiments of the invention the use of the available resources of the workflow system can be improved and/or optimized to help to prevent deadlocks and to speed-up workflow processing time.

Embodiments of the invention allow to take into account the current status of the workflow system and to assign the tasks at runtime. This facilitates the reduction of deadlocks and the increase of through-put. According to embodiments of the invention the workflow engine of the workflow system assigns the tasks automatically and dynamically at runtime to the users.

According to embodiments of the invention, the workflow system comprises a plurality of roles, each role having a quantity of users as members. The members of each role can be often defined on the basis of a corresponding policy. A system with a design of that kind is also called a role-based access control system (RBAC).

According to a further embodiment of the invention, each role has a ranking that runs inverse to the quantity of users it has as members and a user's flexibility to perform the tasks is determined on the basis of the sum of the rankings of the roles the user is a member of.

This embodiment provides an easy-to-implement approach for determining the users' flexibility to perform other tasks. A user who is a member of a small number of groups while the groups he/she is a member of have only few members may be considered inflexible with respect to his ability to perform other tasks. On the other hand, a user who is a member of many groups and/or the groups he/she is a member of have many users as members may be considered flexible. The given heuristic is a good approximation to the effective flexibility of the user.

According to another embodiment of the invention the users' flexibility to perform other tasks is determined on the basis of the number of tasks in the workflow system the user is authorized to perform. Determination of this number may involve determination of the roles the user is member of and then summing up the tasks that members of these roles are authorized to perform. According to this embodiment, the determination of the users' flexibility may be implemented as a fast and lightweight process.

According to a further embodiment of the invention, among users with the same determined flexibility, the user having the lowest number of existing assignments to other tasks is selected. This may help to distribute tasks over all users and thus make better or optimized use of the available resources, i.e. users. According to a further embodiment of the invention, in case of more than one user having a lowest number of existing assignments, the user may be selected randomly.

According to a further embodiment, among users with the same determined flexibility, the user may be selected randomly. Among users with equal flexibility to perform other tasks in the workflow system, the number of tasks assigned to each user may thus be further leveled if a large enough number of cases are considered.

According to a further embodiment of the method, the determination of the set of users may be carried out in two parts. A first part may be carried out before the task is received and the second part may be carried out after the task is received and on the basis of the result of the first part. Particularly, the first part may comprise applying a static policy which does not need consideration of a current state of a user and/or a task to determine a raw set of users who are authorized to perform a task. The second part of the determination may comprise a dynamic policy to provide a finer set of users on the basis of the raw set. In this way, a part of the necessary determination of the set may be carried out at an early time when computing resources may be better available and computing time may be less precious. This may speed up the part of the determination process that can only be carried out after the task is received. Workflow delay during task assignment to a user may thus be minimized and overall system throughput may be further optimized.

A computer-program product with programming means implementing the described method may be stored on a computer-readable medium. The computer-program product may furthermore be executed on a processing unit.

According to an embodiment of another aspect of the invention, a system for assigning a task in a workflow system to a user of the workflow system comprises reception means for receiving the task, determination means for determining a set of users who are authorized to perform the received task, a selection unit for selecting a user from the set who has the lowest flexibility to perform other tasks in the workflow system, and assignment means for assigning the task to the selected user.

Advantageously, the system comprises a programmable computer and preferably said programmable computer is adapted to execute the above-described method.

According to an embodiment of another aspect of the invention a computer system for assigning a task of a workflow system to a user of the workflow system is provided. The system includes an input interface for receiving the task; a memory unit for storing user authorizations; a processing unit being operable to determine a set of users who are authorized to perform the received task and to select from the set a user who has the lowest flexibility to perform other tasks of the workflow system; and to assign the task to the selected user.

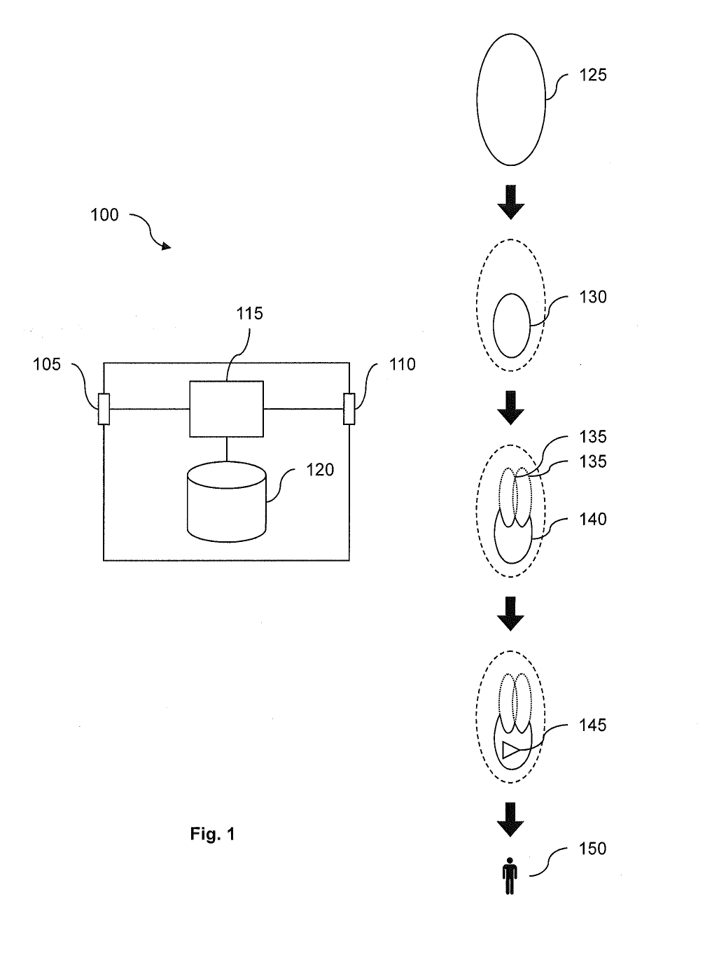

FIG. 1 shows a system 100 for assigning a task in a workflow system to a user of the workflow system. In the following, a unit of work is called a task and a workflow models the temporal ordering and causal dependencies of tasks that together implement a business objective. A workflow system is the entirety of workflows and, where applicable, the physical means to carry out workflows. The system 100 may represent the physical entity where a decision-making process called workflow engine of the workflow system is located. In this sense, the system 100 also represents the workflow system. Examples for systems with a workflow engine include IBM WebSphere Process Server, IBM WebSphere Lombardi Edition and IBM Tivoli Identity Manager.

The system 100 includes an input interface 105, an output interface 110, a processing unit 115 and as memory unit a database 120. The database 120 may store, e.g., user authorizations and a policy for assigning tasks to the users. The system 100 may be part of a computer installation comprising one or several computers, preferably interconnected by a computer network.

The system 100 is adapted to carry out a control process called workflow engine for activities such as determining the next task to be executed and assigning that task to a user. The sub-process of selecting a user for assignment is sketched as a series of graphical sets on the right-hand side of FIG. 1. An entirety of users 125 that may be represented by some data structure inside of the database 120 is subjected to a first selection step in which authorized users 130, who have permission to carry out the task to be assigned, are selected. Following that, indisposed users 135 are identified and removed from the authorized users 130, leaving a set of users 140. In some cases, this requires the context of the specific task to be assigned and is thus carried out only after the task has been identified. To the set of users 140, a heuristic approach is applied that identifies candidates 145 for carrying out the given task. Among the users of the system 100 who have permission and are available to perform the task at hand, the candidates 145 represent those with the lowest flexibility to perform other tasks in the workflow system 100. Finally, one user 150 is selected from the set of candidates 145, and the task is assigned to the selected user 150.

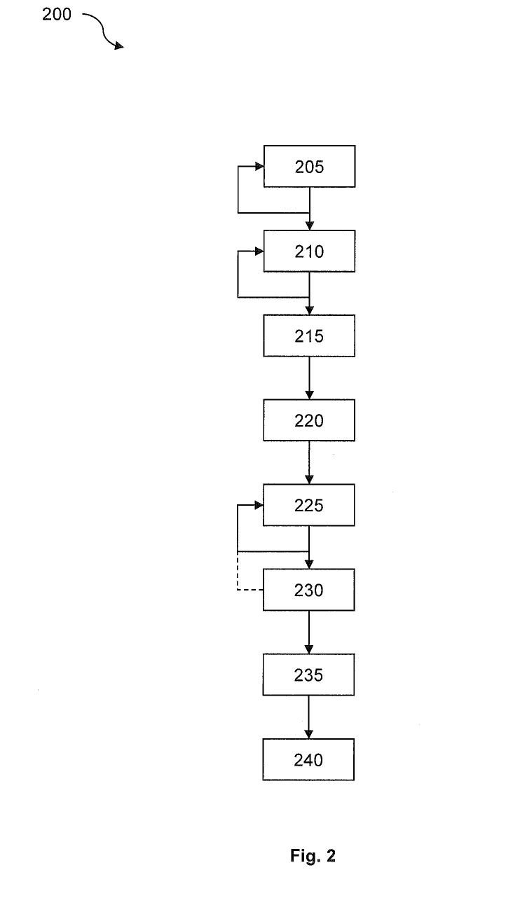

FIG. 2 shows a flowchart of a method 200 for assigning a task to a user. The depicted method 200 is known as “counting role assignments” and adapted to be carried out on the system 100 of FIG. 1.

In a first block 205, a first set of users 150 who are generally capable of carrying out a task is determined. That is, the first set of users 150 comprises users 150 who have the permission to carry out the task at hand. In order to select all the users 150 with matching permissions from the entirety of users 150 in the system 100, every single user 150 may be individually checked whether or not he/she is allowed to perform the task. In a role based access control system 100, the determination may instead be accomplished by identifying user roles that are associated with the permission to carry out the task and then selecting the members of those roles. In this context, a role represents a set of users 150 with an ability to perform a specific task or a class of tasks. The members of the group may be determined by manual assignment and/or by applying a policy, which is a set of rules, often based on attributes that are assigned to the users 150. The policy may be static in that it does not consider a state of a user 150, the role, a task or any other dynamic component of the system 100.

In different embodiments, rules applied inside of block 205 may also comprise a dynamic policy which considers a state of the user, the role and/or the task at the time of the determination. Additionally or alternatively, a user 150 may be manually assigned to or removed from a role. In yet another embodiment, block 205 may be omitted.

In a preceding or following block 210, each role in the workflow system 100 is assigned a rank. In a preferred embodiment, the rank of a role runs inverse to the quantity of users 150 it has as members. For example, assume that the entirety 125 of users 150 comprises N users 150. A role that has M users 150 as members may then have a rank of N-M. The rank of each role may be weighed according to other parameters of the workflow system 100 and/or be dependent on further parameters.

In block 215, the task to be assigned is received. Any of blocks 205, 210 may also be carried out after block 215. However, it is desirable to keep processing time after block 215 as low as possible, as a reaction time of system 100 upon the creation of a task is often judged by the time method 200 spends between block 215 and terminating.

In block 220, the set of users that was determined in block 205 is refined to yield a set of users who are authorized to perform the received task. In case block 205 was carried out for each role in the system 100, block 220 may involve a determination which roles are assigned to the task received in block 215 and joining the members of all determined roles into one set of users 150. The refinement that is carried out in block 220 may be represented by one or several dynamic policies that consider a state of the user 150, one of the groups the user 150 is member of, the received task and/or another dynamic component of the workflow system 100. For instance, users 150 who are known to be unavailable at a time when the received task must be carried out may be taken out of the set.

In block 225, a classification of flexibility is determined for each user 150 in the set by identifying which roles the user 150 is a member of and summing up the rankings of those roles. The classification may be saved as a temporary attribute of the user.

In a following block 230, those users 150 who have the lowest classification are selected to form a set of candidates to choose from.

Blocks 225 and 230 may be combined so that unnecessary adding is avoided. The classification for a first user 150 is determined, the first user is added to the set of candidates and his/her classification is kept as a minimum. Classification continues for other users 150 of the set previously determined and users 150 having the same classification as the minimum are added to the set of candidates. Summing up role rankings for a second user is stopped when an intermediate total of the summing exceeds the minimum and classification continues for another user 150 in the set. Should the classification of a third user 150 in the set be completed to yield a classification that is smaller than the minimum, all previous candidates are discarded, the minimum is replaced with the classification of the third user 150 and the third user 150 is added to the set of candidates before the remaining users 150 are classified. After classification has been performed for all users 150 in the previously determined set, the set of candidates contains all users 150 having the smallest classification.

The determined set of candidates may contain one or several users 150. Other approaches for finding users 150 with the lowest classification in block 230 are also possible, like sorting the users by classification and then selecting those users 150 with the lowest classification into the set of candidates. In any case, block 230 provides a set of candidates that is populated with users 150 who have the smallest classification.

In a following block 235, one user 150 is selected among those of the set of candidates of block 230. This selection may comprise one of a number of known schemes for making a selection of one item out of a set. Preferably, the selection of block 235 is done in such a way that, for a large enough number of selections, a probability to be selected is roughly the same for all users 150 in the set of candidates. Selection approaches include random or pseudo-random selection, round robin, hashing and other.

In a final block 240, the task received in block 215 is assigned to the user selected in block 235 and the method 200 terminates.

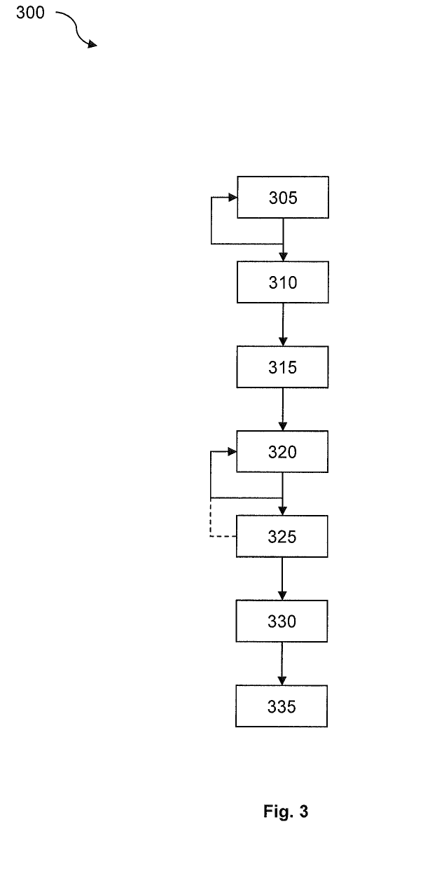

FIG. 3 shows a flowchart of another method 300 known as “choose least authorized” for assigning a task to a user 150. The method 300 differs from method 200 “counting role assignments” above mainly in the way classification of users 150 is performed to find a numerical value for the user's flexibility to perform other tasks. Some of the variations of method 200 mentioned above, especially of those steps preceding and following the actual classification, may also be applied to method 300.

In a first block 305, which is optional, users 150 who are generally capable of carrying out a task are identified. This block corresponds to block 205 of method 200. Here too, this block is preferably carried out for each user role that is defined inside system 100.

Following that, the task is received in block 310. In an alternative embodiment, block 305 may also be carried out after receiving the task in block 310, but this is less favorable as block 305 may prolong execution time of the portion of method 300 after reception of the task in block 310.

In block 315, which is also optional and which is analogous to block 220 of method 200, the selection of users 150 carried out in block 305 may be refined in the light of a state of the task, a role, a state of the users 150 and/or a state of another component of the system 100. Preferably not both of blocks 305, 315 are omitted so that the set of users on which following operations are executed contains only users with the authorization of the received task.

In block 320, the number of tasks each user 150 identified in the previous block is authorized to perform is determined. To do so, all roles a user 150 is member of may be determined and then the numbers of tasks that may be carried out by members of those roles are added. In other embodiments direct task authorizations may be available for the users so that determination of associated roles may not be necessary. The determined number of authorized tasks for each user is used as classification of the user's flexibility to perform other tasks.

In a following block 325, a set of candidates of users 150 having the lowest classification as of block 320 is determined. As explained in more detail above with respect to blocks 225 and 230 of method 200, blocks 320 and 325 may advantageously be combined in order to skip adding operations that will not lead to a new user 150 in the set of candidates.

Next, in block 330 which corresponds to block 235 of method 200, one user 150 is selected from the set of candidates determined in block 325. Finally, in block 335, the task received in block 310 is assigned to the user selected in block 330.

The approaches of methods 200 and 300 will now be discussed in more detail with reference to an example workflow.

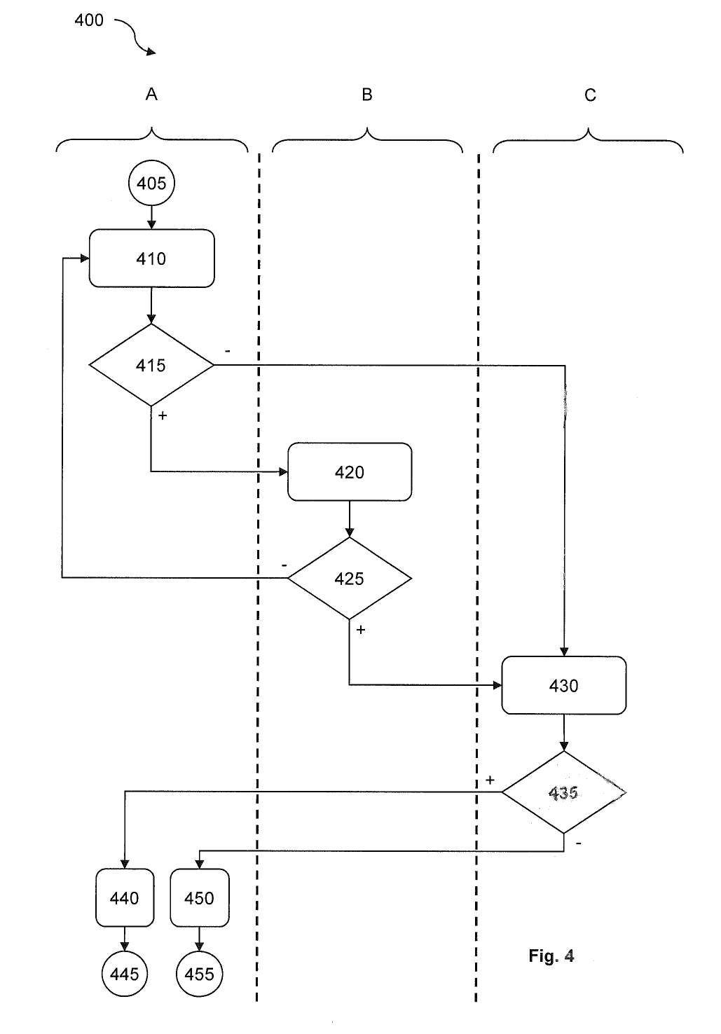

FIG. 4 shows a flowchart for an exemplary workflow 400.

Workflow 400 describes tasks and associated tests that are executed to originate a loan in a bank. Tasks are shown as rectangles, tests as diamonds and interface steps are shown as circles. The operations of workflow 400 are depicted in different areas A, B and C which correspond to the roles of accountant, loan specialist and manager, respectively. When determining which of the users 150 should be assigned a task, it is necessary to select a user 150 who is a member of the role that corresponds to the task in question.

Upon receipt of a loan request in interface block 405, an accountant prepares a loan arrangement in task 410 and checks whether a specialist check is required in test 415. If this is the case, a loan specialist checks the conditions of the loan arrangement in task 420. If the conditions are approved in subsequent test 425, or if a specialist check was not found necessary in test 415, a manager is requested to approve the origination in task 430. If the conditions in block 425 are not approved, an accountant (preferably the same accountant as before) is assigned the preparation of a loan arrangement in task 410 again.

In test 435 following task 430, the manager determines if an approval was made. In the positive, an accountant is assigned task 440 of finalizing the arrangement and the finalization is relayed to the requestor in interface block 445. If an approval is found to be refused in test 435, an accountant is assigned task 450 of preparing a rejection and the rejection is relayed to the requestor in interface block 455.

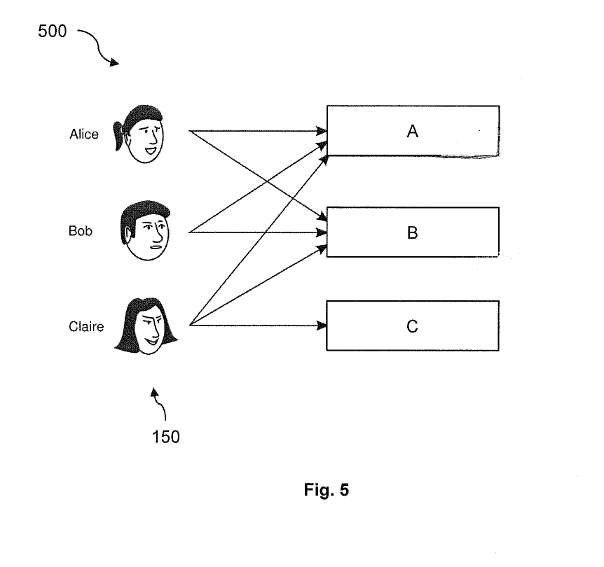

FIG. 5 shows an exemplary relationship between exemplary users 150 and roles A, B, C in the workflow 400 of FIG. 4.

Three users 150 called Alice, Bob and Claire are members of different roles A, B and C of workflow 400. Alice and Bob are both members of roles A (accountant) and B (loan specialist). Claire shares roles A and B and is additionally member of role C (manager).

To model the dynamic policies mentioned above with respect to blocks 220 and 315, it is assumed that users 150 executing instances of task 420 (check conditions) and 430 (approve origination), must be different from those who execute instances of task 410 (prepare loan arrangement). Such a constraint is called a separation of duties (SOD) and may be implemented through a static or dynamic rule or policy or a combination thereof.

First, the application of method 200 “counting role assignments” as explained above with respect to FIG. 2 to the workflow 400 of FIG. 4 will be discussed. When executing method 200, the role rankings for roles A, B and C are determined in block 210. There are three users available, therefore a role with only one member is assigned a ranking of 3−1=2 and a role with two members is assigned a ranking 3−2=1. The following ranking emerges:

TABLE 1

| | |
|---|---|
| A (accountant) | 1 |
| B (loan specialist) | 1 |
| C (manager) | 2 |

From this follows a summed role ranking for the users 150 in block 225:

TABLE 2

| | |
|---|---|
| Alice: 1 + 1 | 2 |
| Bob: 1 + 1 | 2 |
| Claire: 1 + 1 + 2 | 4 |

Table 2 reflects each user's flexibility to execute tasks in the workflow system 100. Claire, as a manager, is member of all roles A, B and C and therefore has the highest flexibility to carry out any of the tasks of workflow 400. This high flexibility is reflected in her summed role ranking of 4. Alice and Bob share the same group memberships and therefore have the same summed role ranking of 2. Their flexibility to carry out other tasks is lower than Claire's.

Any time a task of workflow 400 must be assigned to one of the users 150 Alice, Bob and Claire, one of Alice and Bob will receive an assignment first and Claire will be saved for later. This heuristic helps to decrease the probability of a case where a generalist (Claire) has already carried out a task of the workflow 400 and, due to the separation of duty constraint mentioned above, may not carry out another task while the other users (Alice and Bob) are specialists in that they lack the role membership to carry out the task at hand.

It is assumed that the task 410 (prepare loan arrangement) is assigned to Alice by way of a random selection between Alice and Bob. It is further assumed that task 420 of checking the loan conditions is required. Due to the separation of duty constraint when assigning task 420 to a user 150, a choice must be made between Bob and Claire. Since Bob has a lower flexibility, as shown in above table 2, he is assigned the task 420 to check the loan conditions. Later on, the task 430 (approve origination) must be assigned to a user 150. Only Claire is member of the manager role C with authorization to task 430 and thus Claire is assigned the task. Finally, one of tasks 440 (finalize arrangement) or 450 (prepare rejection) must then be assigned. It is assumed that Alice is considered busy performing block 410 (prepare loan arrangement), so Bob is assigned task 440 or 450, respectively.

The same workflow 400 is now discussed using method 300 “chose least authorized” as explained above with respect to FIG. 3. First, the number of tasks each of the users Alice, Bob and Claire is authorized to perform is determined in block 320:

TABLE 3

| | |
|---|---|
| Alice's tasks: 410, 440, 450, 420 | 4 |
| Bob's tasks: 410, 440, 450, 520 | 4 |
| Claire's tasks: 410, 440, 450, 420, 430 | 5 |

An execution of the workflow 400 is considered in which task 420 (check conditions) is required and the origination is approved in task 430. First, the task 410 (prepare loan arrangement) must be assigned to a user 150 and Alice, Bob and Claire form the set for the choice as they are each authorized and available. According to table 3, Alice and Bob have the same low number of tasks they may perform and thus one of them is chosen first for the assignment. Let Bob be chosen at random. Due to the separation of duty constraint, the set of users authorized to execute task 420 (check conditions) is altered and the number of tasks each user is allowed to perform changes into:

TABLE 4

| | |
|---|---|
| Bob: 410, 440, 450 | 3 |
| Alice: 410, 440, 450, 420 | 4 |
| Claire: 410, 440, 450, 420, 430 | 5 |

For assigning task 420 to a user 150, the set of authorized users comprises only Alice and Claire. Because of her lower flexibility to perform other tasks compared to Claire, Alice is assigned task 420 (check conditions).

For execution of task 430 (approve origination), Claire is the only user authorized and is therefore assigned this task. Finally, Bob is assigned the execution of task 440 (finalize arrangement) because his flexibility is considered lowest according to table 4.

Any disclosed embodiment may be combined with one or several of the other embodiments shown and/or described. This is also possible for one or more features of the embodiments.

The described techniques may be implemented as a method, apparatus or article of manufacture involving software, firmware, micro-code, hardware and/or any combination thereof. The term “article of manufacture” as used herein refers to code or logic implemented in a medium, where such medium may comprise hardware logic [e.g., an integrated circuit chip, Programmable Gate Array (PGA), Application Specific Integrated Circuit (ASIC), etc.] or a computer readable medium, such as magnetic storage medium (e.g., hard disk drives, floppy disks, tape, etc.), optical storage (CD-ROMs, optical disks, etc.), volatile and non-volatile memory devices [e.g., Electrically Erasable Programmable Read Only Memory (EEPROM), Read Only Memory (ROM), Programmable Read Only Memory (PROM), Random Access Memory (RAM), Dynamic Random Access Memory (DRAM), Static Random Access Memory (SRAM), flash, firmware, programmable logic, etc.]. Code in the computer readable medium is accessed and executed by a processor. The medium in which the code or logic is encoded may also comprise transmission signals propagating through space or a transmission media, such as an optical fiber, copper wire, etc. The transmission signal in which the code or logic is encoded may further comprise a wireless signal, satellite transmission, radio waves, infrared signals, Bluetooth, etc. The transmission signal in which the code or logic is encoded is capable of being transmitted by a transmitting station and received by a receiving station, where the code or logic encoded in the transmission signal may be decoded and stored in hardware or a computer readable medium at the receiving and transmitting stations or devices. Additionally, the “article of manufacture” may comprise a combination of hardware and software components in which the code is embodied, processed, and executed. Of course, those skilled in the art will recognize that many modifications may be made without departing from the scope of embodiments, and that the article of manufacture may comprise any information bearing medium. For example, the article of manufacture comprises a storage medium having stored therein instructions that when executed by a machine results in operations being performed.

Certain embodiments can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, certain embodiments can take the form of a computer program product accessible from a computer usable or computer readable medium providing program code for use by or in connection with a computer or any instruction execution system. For the purposes of this description, a computer usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

The terms “certain embodiments”, “an embodiment”, “embodiment”, “embodiments”, “the embodiment”, “the embodiments”, “one or more embodiments”, “some embodiments”, and “one embodiment” mean one or more (but not all) embodiments unless expressly specified otherwise. The terms “including”, “comprising”, “having” and variations thereof mean “including but not limited to”, unless expressly specified otherwise. The enumerated listing of items does not imply that any or all of the items are mutually exclusive, unless expressly specified otherwise. The terms “a”, “an” and “the” mean “one or more”, unless expressly specified otherwise.

Devices that are in communication with each other need not be in continuous communication with each other, unless expressly specified otherwise. In addition, devices that are in communication with each other may communicate directly or indirectly through one or more intermediaries. Additionally, a description of an embodiment with several components in communication with each other does not imply that all such components are required. On the contrary a variety of optional components are described to illustrate the wide variety of possible embodiments.

Further, although process steps, method steps, algorithms or the like may be described in a sequential order, such processes, methods and algorithms may be configured to work in alternate orders. In other words, any sequence or order of steps that may be described does not necessarily indicate a requirement that the steps be performed in that order. The steps of processes described herein may be performed in any order practical. Further, some steps may be performed simultaneously, in parallel, or concurrently.

When a single device or article is described herein, it will be apparent that more than one device/article (whether or not they cooperate) may be used in place of a single device/article. Similarly, where more than one device or article is described herein (whether or not they cooperate), it will be apparent that a single device/article may be used in place of the more than one device or article. The functionality and/or the features of a device may be alternatively embodied by one or more other devices which are not explicitly described as having such functionality/features. Thus, other embodiments need not include the device itself.

Computer program means or computer program in the present context mean any expression, in any language, code or notation, of a set of instructions intended to cause a system having an information processing capability to perform a particular function either directly or after either or both of the following a) conversion to another language, code or notation; b) reproduction in a different material form.

1. A computer-implemented method for assigning a task in a workflow system to a user of the workflow system, the method comprising:
receiving the task;
determining, by a computer, a set of users who are authorized to perform the received task;
selecting from the set a user who has the lowest flexibility to perform other tasks in the workflow system; and
assigning the task to the selected user.

2. The method according to claim 1, wherein the set of users is determined on the basis of a policy which is dynamic in that it considers a state of the user and/or the task at the time of determining the set.

3. The method according to claim 1, wherein the workflow system comprises a plurality of roles, each role having a quantity of users as members, the members of each role being defined on the basis of a corresponding policy.

4. The method according to claim 3, wherein:
each role has a ranking that runs inverse to the quantity of users it has as members;
a user's flexibility to perform other tasks is determined on the basis of the sum of the rankings of the roles the user is member of.

5. The method according to claim 3, wherein a user's flexibility to perform other tasks is determined on the basis of the number of tasks in the workflow system the user is authorized to perform.

6. The method according to claim 1, wherein among users with equal flexibility to perform other tasks in the workflow system, a user is selected that has the lowest number of existing assignments to other tasks in the workflow system.

7. The method according to claim 1, wherein among users with equal flexibility to perform other tasks in the workflow system, the user is selected randomly.

8. The method according to claim 1, further comprising determining, for a plurality of possible tasks of the workflow system, a first set of users who are authorized to perform a task before the task is received, wherein determination of the set of users who are authorized to perform the received task is performed on the basis of the corresponding first set of users.
